(19) United States
(12) Patent Application Publication
(10) Pub. No.: US 2026/0149196 A1
(43) Pub. Date: May 28, 2026

(54) TERMINAL HOLDER AND TERMINAL

(71) Applicant: SUMITOMO WIRING SYSTEMS, LTD., Mie (JP)

(72) Inventor: Daisuke KATAOKA, Mie (JP)

(21) Appl. No.: 19/377,523

(22) Filed: Nov. 3, 2025

(30) Foreign Application Priority Data
Nov. 11, 2024 (JP) 2024-196621

(51) Int. Cl. H01R 4/70

(52) U.S. Cl. CPC H01R 4/70

(57) ABSTRACT

A terminal holder includes a terminal accommodating portion for accommodating a terminal with an upper surface of the terminal exposed. The terminal holder includes a temporary positioning mechanism for temporarily positioning the terminal in an insertion posture in the terminal accommodating portion in a process of accommodating the terminal into the terminal accommodating portion. The terminal holder includes a locking mechanism for locking the terminal in the terminal accommodating portion when the terminal temporarily positioned by the temporary positioning mechanism is pushed and accommodated into the terminal accommodating portion. The terminal is fixed to the terminal accommodating portion by the temporary positioning mechanism and the locking mechanism.

### CROSS-REFERENCE TO RELATED APPLICATIONS

This application is based on and claims priority from Japanese Patent Application No. 2024-196621, filed on November 11, 2024, with the Japan Patent Office, the disclosure of which is incorporated herein in its entirety by reference.

### TECHNICAL FIELD

The present invention relates to a terminal holder and a terminal.

### BACKGROUND

Conventionally, a protector is known which is provided with a wire accommodating portion for accommodating a wire and a terminal accommodating portion for accommodating a terminal mounted on an end part of a branch line of the wire as disclosed in Japanese Patent Laid-open Publication No. 2012-235623. The terminal accommodating portion includes a body portion having an opening shape for accommodating the terminal and a lid portion for opening and closing an opening of the body portion.

### SUMMARY

However, in the case of Japanese Patent Laid-open Publication No. 2012-235623, the terminal accommodated in the terminal accommodating portion is held by being sandwiched between the body portion and the lid portion of the terminal accommodating portion. Thus, the lid portion for holding the terminal accommodated in the terminal accommodating portion is necessary in the case of Japanese Patent Laid-open Publication No. 2012-235623. This has hindered the simplification of a structure.

The present disclosure aims to provide a terminal holder and a terminal capable of simplifying a structure.

A terminal holder for solving the above problem is provided in a case for accommodating a wire having a terminal mounted on a tip, the terminal being fixed to a connection partner via a fastening member, and provided with a terminal accommodating portion for accommodating the terminal with an upper surface of the terminal exposed, a temporary positioning mechanism for temporarily positioning the terminal in an insertion posture in the terminal accommodating portion in a process of accommodating the terminal into the terminal accommodating portion, and a locking mechanism for locking the terminal in the terminal accommodating portion when the terminal temporarily positioned by the temporary positioning mechanism is pushed and accommodated into the terminal accommodating portion, the terminal being fixed to the terminal accommodating portion by the temporary positioning mechanism and the locking mechanism.

The present disclosure can simplify the structure of a terminal holder.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal holder according to one embodiment.

FIG. 2 is an exploded perspective view of the terminal holder.

FIG. 3 is a plan view of a terminal.

FIG. 4 is a perspective view before the terminal is mounted in a terminal accommodating portion.

FIGS. 5A to 5C are diagrams showing a procedure when the terminal is mounted into the terminal accommodating portion.

FIG. 6 is a perspective view before the terminal is mounted into the terminal accommodating portion.

FIG. 7 is a section showing an operational summary of inserting the terminal into the terminal accommodating portion.

FIGS. 8A to 8C are diagrams showing the procedure when the terminal is mounted into the terminal accommodating portion.

FIG. 9 is an action diagram of a temporary positioning mechanism and a locking mechanism.

FIG. 10 is a perspective view showing the engagement of a slit of the terminal and a wall portion of the terminal accommodating portion.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Description of Embodiments of Present Disclosure]

First, embodiments of the present disclosure are listed and described.

[1] The terminal holder of the present disclosure is provided in a case for accommodating a wire having a terminal mounted on a tip, the terminal being fixed to a connection partner via a fastening member, and provided with a terminal accommodating portion for accommodating the terminal with an upper surface of the terminal exposed, a temporary positioning mechanism for temporarily positioning the terminal in an insertion posture in the terminal accommodating portion in a process of accommodating the terminal into the terminal accommodating portion, and a locking mechanism for locking the terminal in the terminal accommodating portion when the terminal temporarily positioned by the temporary positioning mechanism is pushed and accommodated into the terminal accommodating portion, the terminal being fixed to the terminal accommodating portion by the temporary positioning mechanism and the locking mechanism.

According to this configuration, since the temporary positioning mechanism and the locking mechanism for fixing the terminal in the terminal accommodating portion are provided between the terminal and the terminal accommodating portion, the terminal can be fixed to the terminal accommodating portion without using a lid. Thus, the terminal accommodating portion of the terminal holder needs not be provided with a lid. Therefore, the structure of the terminal holder can be simplified.

[2] In [1] described above, the temporary positioning mechanism has a structure including a protrusion formed on one of the terminal and the terminal accommodating portion and a recess formed in the other of the terminal and the terminal accommodating portion to be engaged with the protrusion. According to this configuration, the terminal can be temporarily positioned in the insertion posture in the terminal accommodating portion by simple configuration and operation of engaging the protrusion formed on the one of the terminal and the terminal accommodating portion with the recess formed in the other of these. Further, if the terminal is completely accommodated in the terminal accommodating portion, the terminal can be firmly fixed to the terminal accommodating portion by a structure for inserting the protrusion deep into the recess.

[3] In [1] or [2] described above, the temporary positioning mechanism has a structure including a supporting portion formed in the terminal accommodating portion, the supporting portion positioning and supporting the terminal in the insertion posture, and a restricting portion formed in the terminal accommodating portion, the restricting portion restricting a movement of the terminal by sandwiching a part of the terminal between the supporting portion and the restricting portion. According to this configuration, the terminal can be temporarily positioned in the insertion posture in the terminal accommodating portion by placing the terminal on the supporting portion of the terminal accommodating portion and sandwiching the terminal between the supporting portion and the restricting portion of the terminal accommodating portion. Further, if the terminal is completely accommodated into the terminal accommodating portion, the terminal can be firmly fixed to the terminal accommodating portion by the structure for sandwiching the terminal between the supporting portion and the restricting portion.

[4] In [3] described above, the temporary positioning mechanism includes a contact portion formed in the terminal for contacting the restricting portion and a pair of terminal protrusions formed on both sides of the contact portion in the terminal, the pair of terminal protrusions being positioned by the supporting portions when the terminal is inserted in the insertion posture into the terminal accommodating portion, and a plurality of pairs of the supporting portion and the terminal protrusion are provided. According to this configuration, since the terminal is structured to be locally supported in the terminal accommodating portion, a large arrangement space for providing the temporary positioning mechanism needs not be provided.

[5] In any one of [1] to [4] described above, the temporary positioning mechanism includes a plurality of differently structured components. According to this configuration, the terminal can be firmly fixed to the terminal accommodating portion by these temporary positioning mechanism and locking mechanism, using the plurality of differently structured components of the temporary positioning mechanisms. Further, when the terminal is fixed to the connection partner by the fastening member, the terminal hardly moves in the lift-up direction. Further, even if a load is applied in a fastening direction of the fastening member, a stress is dispersed by the plurality of mechanisms, wherefore the terminal holder is hardly damaged.

[6] In any one of [1] to [5] described above, the terminal holder is provided with a guiding mechanism for guiding the terminal in the insertion posture to the temporary positioning mechanism when the terminal is inserted into the terminal accommodating portion. According to this configuration, the terminal can be smoothly accommodated into the terminal accommodating portion by the guiding mechanism. Therefore, the efficiency of the assembly workability of the terminal holder can be efficiently improved.

[7] In any one of [1] to [6] described above, the terminal accommodating portion is formed with a wall portion to be engaged with a slit of the terminal to make the terminal fixed to the terminal accommodating portion hardly move. According to this configuration, a movement of the terminal accommodated in the terminal accommodating portion can be restricted by the wall portion. Thus, when the terminal is fixed to the connection partner by the fastening member, a movement of the terminal in the lift-up direction is further suppressed and it is also suppressed that a load in the fastening direction of the fastening member is locally generated in the terminal and the terminal holder.

[8] In any one of [1] to [7] described above, a part temporarily positioned by the temporary positioning mechanism is a tip of the terminal, and a part locked by the locking mechanism is a part around a crimping portion in the terminal including the crimping portion to be fixed to the wire. According to this configuration, the terminal is fixed and positioned in a well-balanced manner, which further contributes to the firm fixing of the terminal to the terminal accommodating portion.

[9] A terminal of the present disclosure is to be mounted on a tip of a wire and accommodated into a terminal accommodating portion provided in a case for accommodating the wire with an upper surface of the terminal exposed, and provided with a part to be temporarily positioned in the terminal accommodating portion when the terminal takes an insertion posture in a process of being accommodated into the terminal accommodating portion and to be fixed to the terminal accommodating portion when the terminal is accommodated into the terminal accommodating portion, and a part to be fixed to the terminal accommodating portion by being pushed after temporary positioning, accommodated into the terminal accommodating portion and locked in the terminal accommodating portion. According to this configuration, functions and effects similar to those of [1] described above can be achieved.

### [Details of Embodiment of Present Disclosure]

A specific example of the present disclosure is described below with reference to the drawings. Note that the present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one.

### (Connector 1)

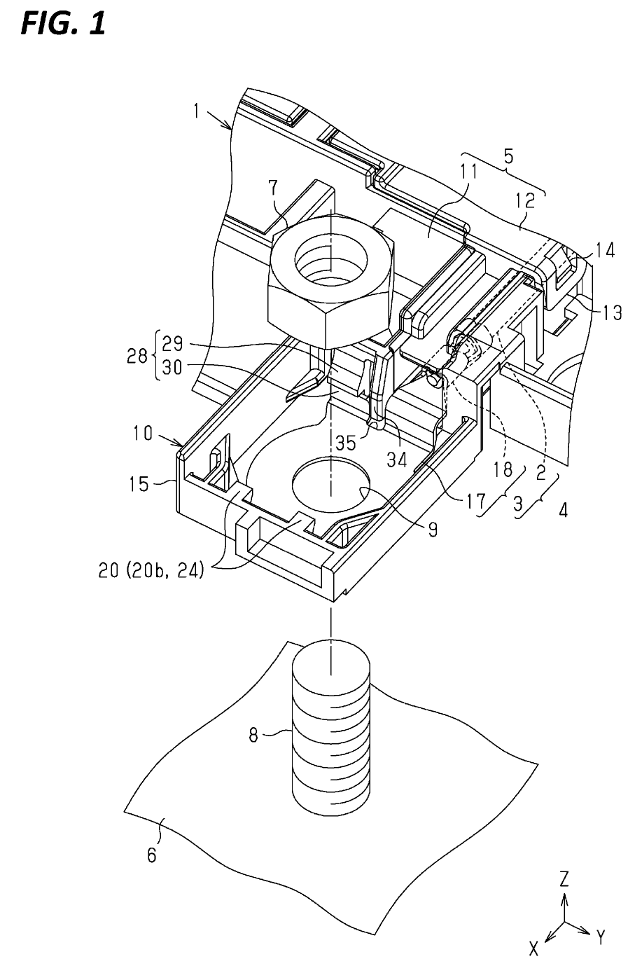

FIG. 1 shows a part of a connector 1. The connector 1 is provided with a wire member 4 having a terminal 3 mounted on the tip of a wire 2 and a case 5 for accommodating the wire member 4. The connector 1 is, for example, used in a battery wiring module for a battery installed in a vehicle. Note that the connector 1 may be provided with a plurality of the wire members 4 or may be provided with only one wire member 4.

The connector 1 is a bolt fastening type connector for fixing the terminal 3 to a connection partner 6 via a fastening member 7 (in this example, a nut). In this case, the terminal 3 is formed with a hole portion 9, through which a fastening shaft 8 formed on the connection partner 6 is inserted. The connector 1 is fixed to the connection partner 6 by fastening the fastening member 7 to the fastening shaft 8 inserted through the hole portion 9 of the terminal 3.

### (Case 5)

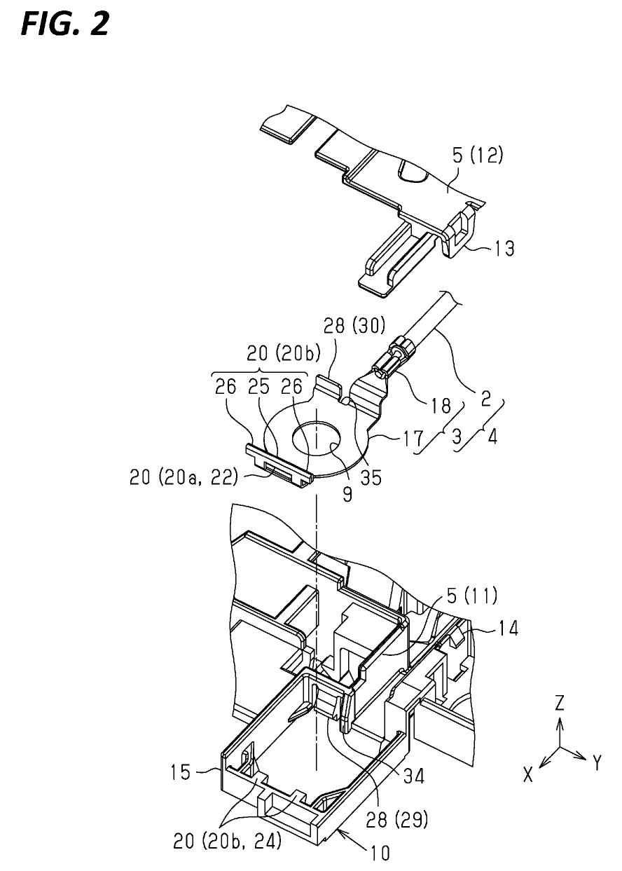

As shown in FIGS. 1 and 2, the case 5 includes a wire accommodating portion 11 for accommodating the wire member 4 and an attachable and detachable cover 12 for covering the wire accommodating portion 11. Note that only parts of the case 5 (the wire accommodating portion 11 and the cover 12) are shown in this example. The cover 12 is fixed to the wire accommodating portion 11 by respectively engaging a plurality of resilient pieces 13 (only one is shown) formed on the cover 12 with a plurality of projections 14 (only one is shown) of the wire accommodating portion 11.

### (Terminal Holder 10)

As shown in FIGS. 1 and 2, the connector 1 is provided with a terminal holder 10 provided on a part of the case 5. The terminal holder 10 includes a terminal accommodating portion 15 for accommodating the terminal 3 with the upper surface of the terminal 3 exposed. The terminal accommodating portion 15 is integrally formed to the wire accommodating portion 11 of the case 5. The wire accommodating portion 11 and the terminal accommodating portion 15 are so provided that accommodation spaces thereof communicate. The terminal accommodating portion 15 is so shaped that both sides in a direction (Z-axis direction of FIG. 1) orthogonal to a plane direction (X-Y plane direction of FIG. 1) of the case 5 are open. Note that the terminal accommodating portion 15 may be integrally formed to the case 5 or may be separately formed and attached and fixed to the case 5.

### (Terminal 3)

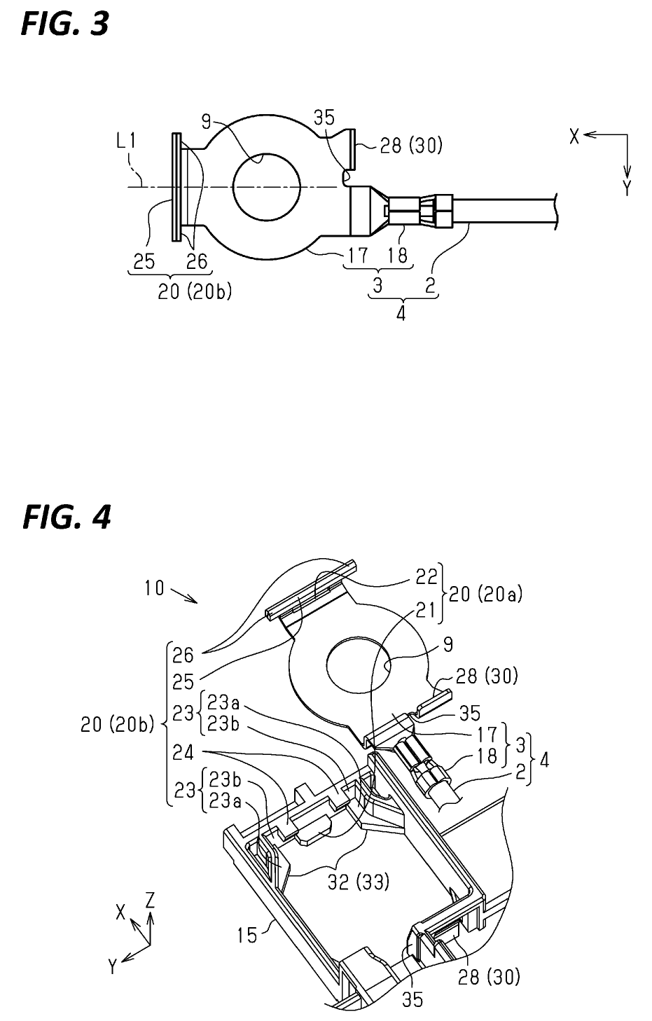

As shown in FIG. 3, the terminal 3 includes a terminal body 17 formed with the hole portion 9 and a crimping portion 18 fixed to an end part of the wire 2 by crimping. The terminal body 17 is, for example, formed into an annular shape in a top view. The crimping portion 18 is arranged at a position offset by a predetermined amount in a direction (Y-axis direction of FIG. 3) intersecting an axis L1 with respect to the axis L passing through a center of the terminal 3 and extending in a length direction.

### (Positioning Mechanism 20)

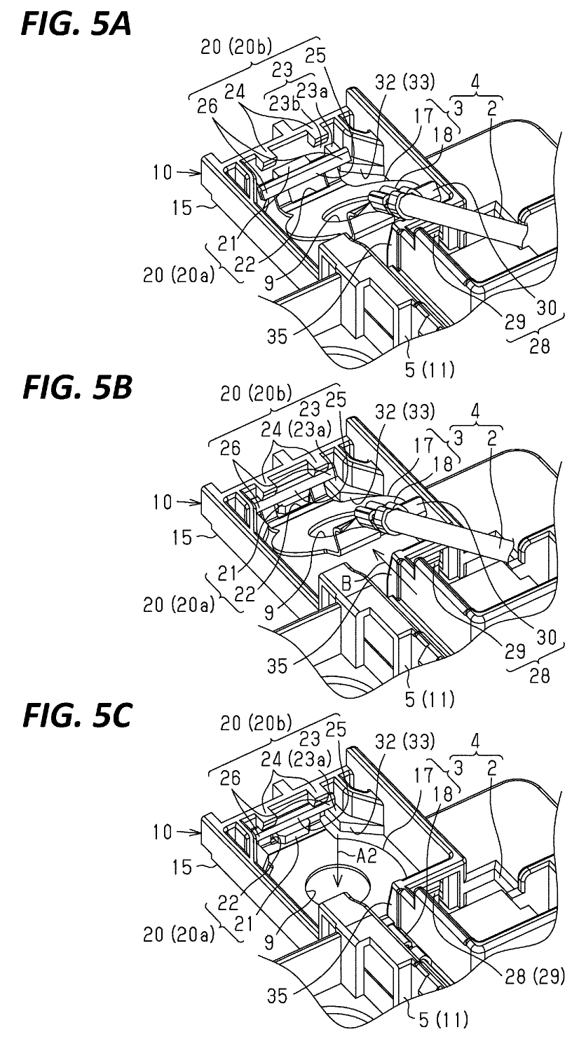

As shown in FIGS. 4 and 5A to 5C, the terminal holder 10 is provided with a temporary positioning mechanism 20 for temporarily positioning the terminal 3 in an insertion posture (for example, a posture shown in FIGS. 5A, 5B and the like) in the terminal accommodating portion 15 in the process of accommodating the terminal 3 into the terminal accommodating portion 15. The temporary positioning mechanism 20 has a structure (in this example, a first temporary positioning mechanism 20a) including, for example, a protrusion 21 formed on one of the terminal 3 and the terminal accommodating portion 15 and a recess 22 formed in the other of the terminal 3 and the terminal accommodating portion 15 to be engaged with the protrusion 21. The protrusion 21 of this example is formed on the terminal accommodating portion 15. Specifically, the protrusion 21 is arranged on the inner surface of the terminal accommodating portion 15 and shaped to project into the inside of the terminal accommodating portion 15. The recess 22 of this example is formed in the terminal 3 and in the form of a through hole.

The temporary positioning mechanism 20 has a structure (in this example, a second temporary positioning mechanism 20b) including supporting portions 23 and restricting portions 24 formed in the terminal accommodating portion 15. The supporting portion 23 includes a bottom portion 23a projecting on the inner surface of the terminal accommodating portion 15 to have a part of the terminal 3 placed thereon and a front wall portion 23b of the terminal accommodating portion 15 intersecting the bottom portion 23a. In this way, the supporting portion 23 positions and supports the terminal 3 in the insertion posture. A pair of the supporting portions 23 are arranged on the inner surface of the terminal accommodating portion 15 and formed to face each other.

The restricting portion 24 is, for example, an upper wall formed in the terminal accommodating portion 15. The restricting portion 24 restricts an upward movement of the terminal 3 by sandwiching a part of the terminal 3 between the supporting portion 23 and the restricting portion 24. A pair of the restricting portions 24 are arranged on an opening end of the terminal accommodating portion 15 and formed at positions facing the protrusion 21 arranged between the pair of supporting portions 23.

The terminal 3 includes a contact portion 25 for contacting the restricting portions 24 and a pair of terminal protrusions 26 formed on both sides of the contact portion 25. As just described, the temporary positioning mechanism 20 (in this example, the second temporary positioning mechanism 20b) includes the contact portion 25 formed in the terminal 3 to contact the restricting portions 24 and the pair of terminal protrusions 26 to be placed on the supporting portions 23 (in this example, the bottom portions 23a) when the terminal 3 is inserted in the insertion posture into the terminal accommodating portion 15. The contact portion 25 is, for example, the tip of the terminal 3. The terminal protrusions 26 are, for example, corner parts (tip lateral projections) on both sides of the terminal tip. A plurality of pairs (in this example, two pairs) of the supporting portion 23 and the terminal protrusion 26 are provided.

As described above, the temporary positioning mechanism 20 of this example includes the first temporary positioning mechanism 20a having the protrusion 21 and the recess 22 and the second temporary positioning mechanism 20b having the supporting portions 23, the restricting portions 24, the contact portion 25 and the terminal protrusions 26. As just described, the temporary positioning mechanism 20 of this example includes a plurality of differently structured components such as the first temporary positioning mechanism 20a and the second temporary positioning mechanism 20b.

### (Locking Mechanism 28)

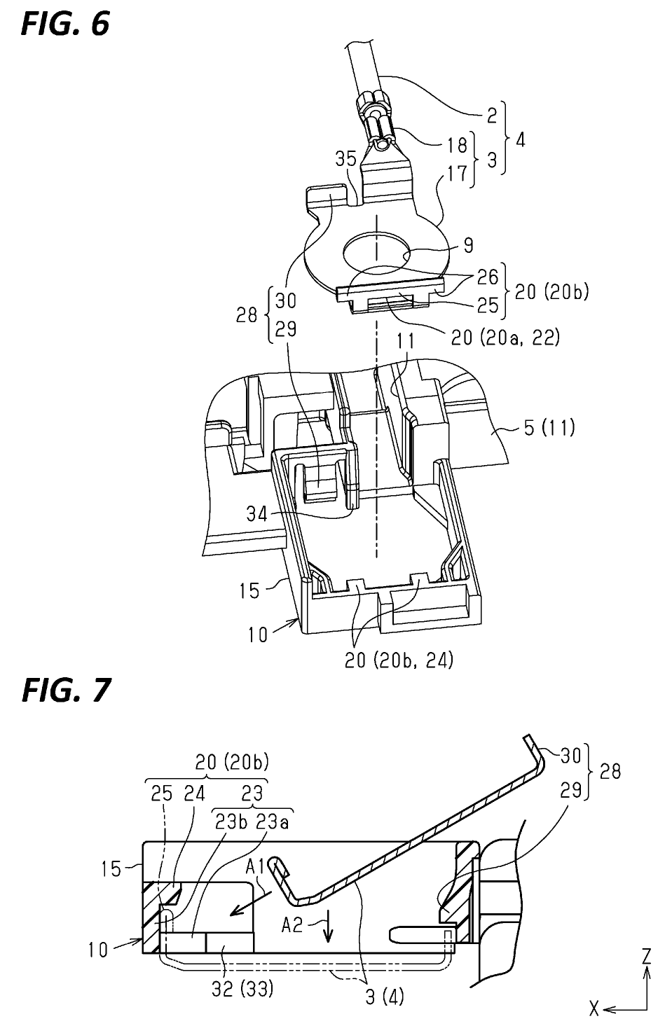

As shown in FIGS. 1 and 6, the terminal holder 10 is provided with a locking mechanism 28 for locking the terminal 3 accommodated into the terminal accommodating portion 15 in the terminal accommodating portion 15. The locking mechanism 28 includes a lock portion 29 formed in the terminal accommodating portion 15 and an engaging piece 30 formed in the terminal 3 to be engaged with this lock portion 29. The lock portion 29 is resiliently deformable and shaped to include a claw on a tip. The engaging piece 30 is formed by bending a part of an end edge of the terminal 3 toward the claw of the lock portion 29 substantially by 90°.

As shown in FIG. 7, the locking mechanism 28 locks the terminal 3 in the terminal accommodating portion 15 when the terminal 3 temporarily positioned by the temporary positioning mechanism 20 is pushed and accommodated into the terminal accommodating portion 15. In the case of this example, the terminal 3 is locked in the terminal accommodating portion 15 by the locking mechanism 28 when being pushed in a push-in direction (direction of an arrow A2 of FIG. 7)) intersecting an insertion direction (direction of an arrow A1 of FIG. 7) and accommodated into the terminal accommodating portion 15.

As shown in FIGS. 1 and 5C and the like, the terminal 3 is fixed to the terminal accommodating portion 15 in parts positioned by the temporary positioning mechanism 20 and parts locked by the locking mechanism 28. In this way, the terminal 3 accommodated in the terminal accommodating portion 15 is fixed to the terminal accommodating portion 15 by the temporary positioning mechanism 20 and the locking mechanism 28.

The parts temporarily positioned by the temporary positioning mechanism 20 include, for example, the recess 22, the contact portion 25 and the terminal protrusions 26 of the terminal 3. Further, the parts temporarily positioned by the temporary positioning mechanism 20 include, for example, the tip of the terminal 3. The parts locked by the locking mechanism 28 include, for example, the engaging piece 30 of the terminal 3. Further, the parts locked by the locking mechanism 28 include a part around the crimping portion 18 in the terminal 3 including the crimping portion 18 to be fixed to the wire 2.

As shown in FIG. 1, the temporary positioning mechanism 20 and the locking mechanism 28 are arranged side by side along the length direction (X-axis direction of FIG. 1) of the terminal 3 arranged on the tip of the wire 2. The crimping portion 18 and the locking mechanism 28 are arranged side by side in a direction (Y-axis direction of FIG. 1) intersecting the aforementioned length direction.

### (Guiding Mechanism 32)

As shown in FIG. 4, the terminal holder 10 is provided with a guiding mechanism 32 for guiding the terminal 3 in the insertion posture to the temporary positioning mechanism 20 when the terminal 3 is inserted into the terminal accommodating portion 15. The guiding mechanism 32 includes guiding pieces 33 for supporting the terminal 3 inserted in the insertion posture into the terminal accommodating portion 15 and placed thereon. The guiding pieces 33 are, for example, shaped to project into the inside of the terminal accommodating portion 15 on inner side surfaces of the terminal accommodating portion 15. In this example, a pair of the guiding pieces 33 are formed to face each other.

In the case of this example, the pair of guiding pieces 33 supports the terminal protrusions 26 formed in the terminal and placed thereon. In this case, the pair of guiding pieces 33 are integrally formed to the supporting portions 23 (in this example, the bottom portions 23a) formed on the same inner side surfaces of the terminal accommodating portion 15. The guiding mechanism 32 of this example supports the terminal 3 accommodated in the insertion posture into the terminal accommodating portion 15 from below and guides a movement of the terminal 3 in a depth direction (+X-axis direction of FIG. 4) of the terminal accommodating portion 15.

### (Wall Portion 34 of Terminal Holder 10)

As shown in FIGS. 1 and 2, the terminal holder 10 is formed with a wall portion 34 in the terminal accommodating portion 15 to be engaged with a slit 35 of the terminal 3 to make the terminal 3 fixed to the terminal accommodating portion 15 hardly rotate. The wall portion 34 is adjacent to the lock portion 29 on the inner surface of the terminal accommodating portion 15. The wall portion 34 is, for example, shaped to project into a space of the terminal accommodating portion 15 and extend in a direction (Z-axis direction of FIG. 1) intersecting a projecting direction (+X-axis direction of FIG. 1) thereof. The slit 35 is a groove formed between the base end of the crimping portion 18 and the engaging piece 30 of the terminal 3.

### Functions of Embodiment

Next, functions of the terminal holder 10 (terminal 3) of this embodiment are described.

(Mounting Procedure of Terminal 3)

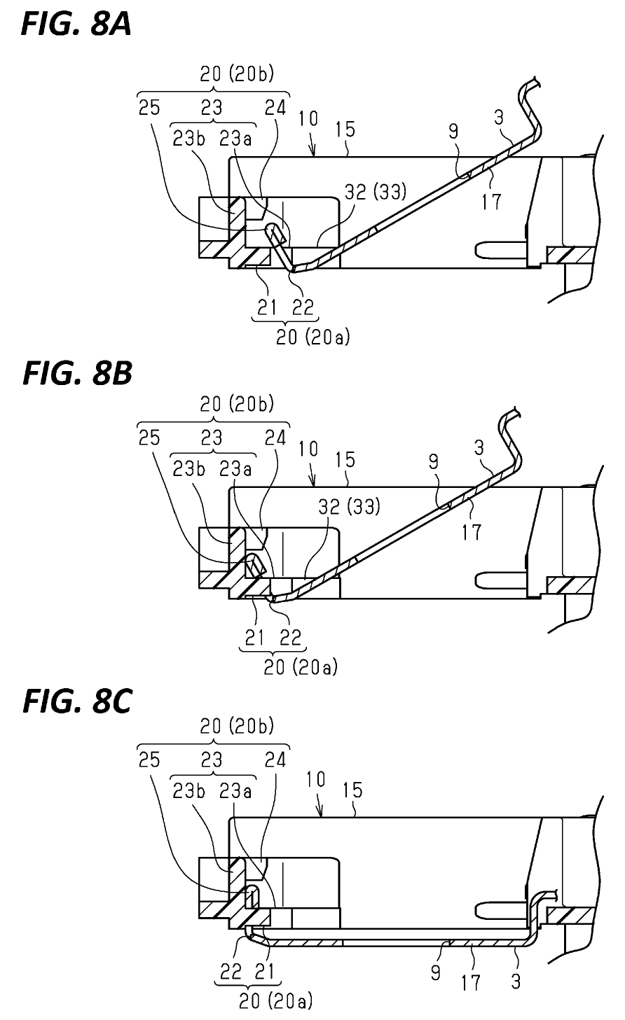

As shown in FIG. 5A and 8A, when the terminal 3 is mounted into the terminal accommodating portion 15, the terminal 3 is inserted into the inside of the terminal accommodating portion 15 in such a posture that the tip thereof is inclined downward. At this time, the terminal protrusions 26 on the tip of the terminal 3 are placed on the guiding pieces 33 of the guiding mechanism 32 and the terminal 3 is inserted into the terminal accommodating portion 15 in such an insertion posture that the protrusion 21 of the terminal accommodating portion 15 is insertable into the recess 22 of the terminal 3. Note that the insertion posture means, for example, such an inclined posture that the tip of the terminal 3 is located on a lower side and the base end of the terminal 3 is located on an upper side.

As shown in FIGS. 5B and 8B, after being accommodated in the insertion posture into the terminal accommodating portion 15, the terminal 3 is inserted into the inside of the terminal accommodating portion 15 by being slid in the depth direction (direction of an arrow B of FIG. 5B) so that the terminal protrusions 26 of the terminal 3 slide on the upper surfaces of the guiding pieces 33 of the terminal accommodating portion 15. In this way, the terminal 3 in the insertion posture is guided in the depth direction of the terminal accommodating portion 15 by the guiding mechanism 32.

If the terminal 3 in the insertion posture is inserted to a deepest part, the protrusion 21 of the terminal accommodating portion 15 is completely inserted into the recess 22 to contact the front wall portions 23b of the supporting portions 23, whereby the contact portion 25 and the terminal protrusions 26 of the terminal 3 are arranged between the supporting portions 23 (specifically, the bottom portions 23a) and the restricting portions 24. That is, the terminal 3 is positioned in the terminal accommodating portion 15 by the first temporary positioning mechanism 20a including the protrusion 21 and the recess 22 and the second temporary positioning mechanism 20b including the supporting portions 23, the restricting portions 24, the contact portion 25 and the terminal protrusions 26.

After the protrusion 21 of the terminal accommodating portion 15 is completely inserted into the recess 22 of the terminal 3 and the contact portion 25 and the terminal protrusions 26 of the terminal 3 are arranged between the supporting portions 23 and the restricting portions 24 of the terminal accommodating portion 15 as shown in FIGS. 5C and 8C, the terminal 3 is pushed in a downward direction (direction of an arrow A2 of FIG. 5C) from above. In this way, the engaging piece 30 of the terminal 3 is locked by the lock portion 29. In the above way, the terminal 3 accommodated in the terminal accommodating portion 15 is fixed to the terminal accommodating portion 15 by the temporary positioning mechanism 20 and the lock portion 29.

### (Features of Terminal Fixing)

As shown in FIG. 1 and the like, a structure for fixing the terminal 3 to the terminal accommodating portion 15 is provided between the terminal 3 and the terminal accommodating portion 15 in the case of this example. Specifically, the terminal 3 is fixed to the terminal accommodating portion 15 by the temporary positioning mechanism 20 and the locking mechanism 28 provided between the terminal 3 and the terminal accommodating portion 15. Thus, even if a lid for closing the terminal accommodating portion 15 is not used, the terminal 3 can be fixed to the terminal accommodating portion 15. Therefore, no lid is necessary for the terminal accommodating portion 15, which contributes to simplifying the structure of the terminal holder 10.

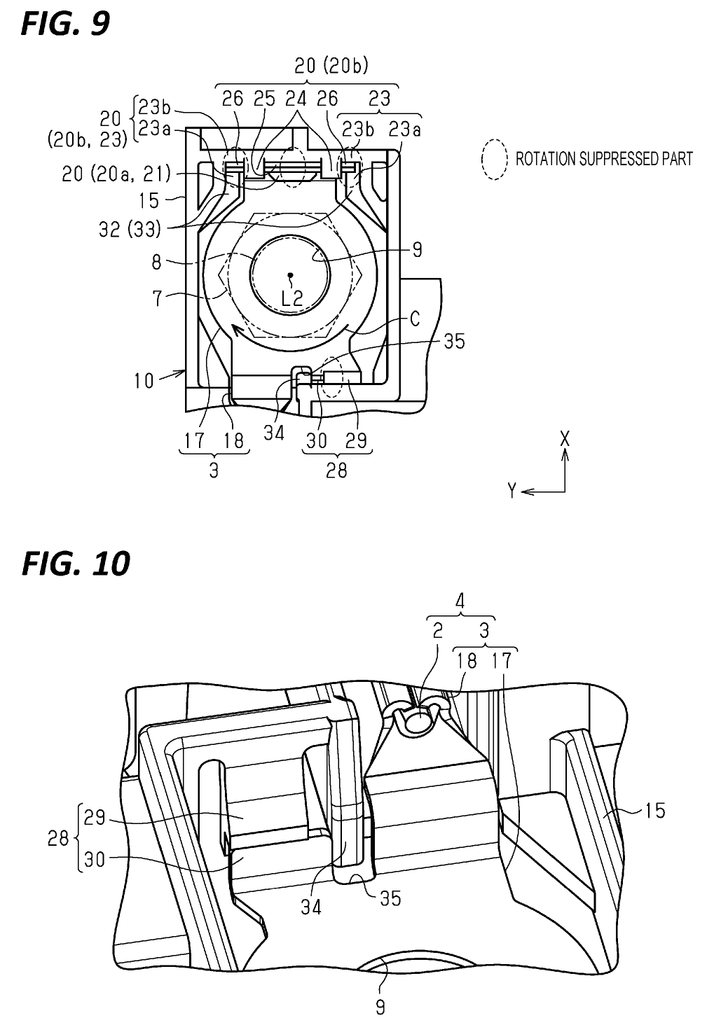

Further, as shown in FIG. 9, the terminal 3 is fixed to the terminal accommodating portion 15 by three mechanisms, i.e. the first temporary positioning mechanism 20a, the second temporary positioning mechanism 20b and the locking mechanism 28. In this way, the terminal 3 is fixed at a plurality of positions by these three mechanisms. Thus, even if the connector 1 includes no lid, the terminal 3 can be firmly fixed to the terminal accommodating portion 15.

There is a possibility that a lift-up load is applied to the terminal 3 from the connection partner 6 and the fastening member 7 when the terminal 3 is fixed to the connection partner 6 by the fastening member 7. However, since a movement of the terminal 3 in a lift-up direction is restricted by the first temporary positioning mechanism 20a, the second temporary positioning mechanism 20b and the locking mechanism 28 in the case of this example, the terminal 3 can be made difficult to lift up. Therefore, the terminal 3 and the connection partner 6 can be fixed in a satisfactory electrical contact state.

Further, when the terminal 3 is fixed to the connection partner 6 by the fastening member 7, a load may be generated in a fastening direction (direction of an arrow C of FIG. 9) of the fastening member 7. At this time, the terminal 3 is rotated about an axial center L2. However, since a rotational movement of the terminal 3 is restricted simultaneously by the first temporary positioning mechanism 20a, the second temporary positioning mechanism 20b and the locking mechanism 28 in the case of this example, a load stress can be dispersed. Therefore, it can be made difficult to deform the terminal 3 and the terminal accommodating portion 15.

Further, as shown in FIG. 10, the wall portion 34 of the terminal accommodating portion 15 is engaged with the slit 35 of the terminal 3. Thus, even if a load is generated in the fastening direction (direction of the arrow C of FIG. 9) of the fastening member 7, the posture of the terminal 3 is easily maintained by the engagement of the wall portion 34 and the slit 35. Therefore, an effect can be said to be high also in this point.

### [Effects of Embodiment]

According to the terminal holder 10 (terminal 3) of the above embodiment, the following effects can be obtained.

(1) The terminal holder 10 is provided in the case 5 for accommodating the wire 2 having the terminal 3 mounted on the tip, and the terminal 3 is fixed to the connection partner 6 via the fastening member 7. The terminal holder 10 is provided with the terminal accommodating portion 15 for accommodating the terminal 3 with the upper surface of the terminal 3 exposed. The terminal holder 10 is provided with the temporary positioning mechanism 20 for temporarily positioning the terminal 3 in the insertion posture in the terminal accommodating portion 15 in the process of accommodating the terminal 3 into the terminal accommodating portion 15. The terminal holder 10 is provided with the locking mechanism 28 for locking the terminal 3 in the terminal accommodating portion 15 when the terminal 3 temporarily positioned by the temporary positioning mechanism 20 is pushed and accommodated into the terminal accommodating portion 15. The terminal 3 is fixed to the terminal accommodating portion 15 by the temporary positioning mechanism 20 and the locking mechanism 28.

According to this configuration, since the temporary positioning mechanism 20 and the locking mechanism 28 for fixing the terminal 3 to the terminal accommodating portion 15 are provided between the terminal 3 and the terminal accommodating portion 15, the terminal 3 can be fixed to the terminal accommodating portion 15 without using a lid. Thus, the terminal accommodating portion 15 of the terminal holder 10 needs not be provided with a lid. Therefore, the structure of the terminal holder 10 can be simplified.

(2) The temporary positioning mechanism 20 has the structure (in this example, the first temporary positioning mechanism 20a) including the protrusion 21 formed on one of the terminal 3 and the terminal accommodating portion 15 and the recess 22 formed in the other of the terminal 3 and the terminal accommodating portion 15 to be engaged with the protrusion 21. According to this configuration, the terminal 3 can be temporarily positioned in the insertion posture in the terminal accommodating portion 15 by simple configuration and operation of engaging the protrusion 21 formed on the one of the terminal 3 and the terminal accommodating portion 15 with the recess 22 formed in the other of these. Further, if the terminal 3 is completely accommodated in the terminal accommodating portion 15, the terminal 3 can be firmly fixed to the terminal accommodating portion 15 by a structure for inserting the protrusion 21 deep into the recess 22.

(3) The temporary positioning mechanism 20 has the structure (in this example, the second temporary positioning mechanism 20b) including the supporting portions 23 formed in the terminal accommodating portion 15 for supporting the terminal 3 in the insertion posture placed thereon and the restricting portions 24 formed in the terminal accommodating portion 15 and configured to restrict a movement of the terminal 3 by sandwiching a part of the terminal 3 between the supporting portions 23 and the restricting portions 24. According to this configuration, the terminal 3 can be temporarily positioned in the insertion posture in the terminal accommodating portion 15 by placing the terminal 3 on the supporting portions 23 of the terminal accommodating portion 15 and sandwiching the terminal 3 between the supporting portions 23 and the restricting portions 24 of the terminal accommodating portion 15. Further, if the terminal 3 is completely accommodated into the terminal accommodating portion 15, the terminal 3 can be firmly fixed to the terminal accommodating portion 15 by the structure for sandwiching the terminal 3 between the supporting portions 23 and the restricting portions 24.

(4) The temporary positioning mechanism 20 (in this example, the second temporary positioning mechanism 20b) includes the contact portion 25 formed in the terminal 3 to contact the restricting portions 24 and the pair of terminal protrusions 26 formed on the both sides of the contact portion 25 in the terminal 3 and to be placed on the supporting portions 23 when the terminal 3 is inserted in the insertion posture into the terminal accommodating portion 15. The plurality of pairs of the supporting portion 23 and the terminal protrusion 26 are provided. According to this configuration, since the terminal 3 is structured to be locally supported in the terminal accommodating portion 15, a large arrangement space for providing the temporary positioning mechanism 20 (in this example, the second temporary positioning mechanism 20b) needs not be provided.

(5) The temporary positioning mechanism 20 includes the plurality of differently structured components. According to this configuration, the terminal 3 can be firmly fixed to the terminal accommodating portion 15 by these temporary positioning mechanism 20 and locking mechanism 28, using the plurality of differently structured components of the temporary positioning mechanisms 20. Further, when the terminal 3 is fixed to the connection partner 6 by the fastening member 7, the terminal 3 hardly moves in the lift-up direction. Further, even if a load is applied in the fastening direction of the fastening member 7, a stress is dispersed by the plurality of mechanisms, wherefore the terminal holder 10 is hardly damaged.

(6) The terminal holder 10 is provided with the guiding mechanism 32 for guiding the terminal 3 in the insertion posture to the temporary positioning mechanism 20 in the case of inserting the terminal 3 into the terminal accommodating portion 15. According to this configuration, the terminal 3 can be smoothly accommodated into the terminal accommodating portion 15 by the guiding mechanism 32. Therefore, the efficiency of the assembly workability of the terminal holder 10 can be efficiently improved.

(7) The terminal holder 10 is formed with the wall portion 34 to be engaged with the slit 35 of the terminal 3 to make the terminal 3 fixed to the terminal accommodating portion 15 hardly rotate. According to this configuration, a movement of the terminal 3 accommodated in the terminal accommodating portion 15 can be restricted by the wall portion 34. Thus, when the terminal 3 is fixed to the connection partner 6 by the fastening member 7, a movement of the terminal 3 in the lift-up direction is further suppressed and it is also suppressed that a load in the fastening direction of the fastening member 7 is locally generated in the terminal 3 and the terminal accommodating portion 15.

(8) The part temporarily positioned by the temporary positioning mechanism 20 is the tip of the terminal 3. The part locked by the locking mechanism 28 is the part around the crimping portion 18 in the terminal 3 including the crimping portion 18 to be fixed to the wire 2. According to this configuration, the terminal 3 is fixed and positioned in a well-balanced manner, which further contributes to the firm fixing of the terminal 3 to the terminal accommodating portion 15.

### [Other Embodiments]

Note that the above embodiment can be modified and carried out as follows. The above embodiment and the following modifications can be combined with each other and carried out without technically contradicting.

● The first temporary positioning mechanism 20a may include the protrusion 21 formed on the terminal 3 and the recess 22 formed in the terminal accommodating portion 15.

● The bottom portions 23a of the second temporary positioning mechanism 20b and the guiding pieces 33 of the guiding mechanism 32 may be formed separately without being integrally formed.

● The second temporary positioning mechanism 20b may be so structured that a part of the terminal 3 is inserted and fixed.

● The second temporary positioning mechanism 20b is not limited to such a structure of sandwiching the contact portion 25 and the terminal protrusions 26 of the terminal 3, but may be structured to sandwich and support a part of the terminal 3.

● The temporary positioning mechanism 20 may include only one of the first and second temporary positioning mechanisms 20a, 20b.

● The engaging piece 30 of the locking mechanism 28 is not limited to the one formed by bending a part of the terminal 3 and may be merely a plate piece.

● The locking mechanism 28 is not limited to the one arranged adjacent to the crimping portion 18 of the terminal 3, but may be formed on an end in a width direction (Y direction of FIG. 1 and the like) of the terminal 3. In this way, the arrangement position of the locking mechanism 28 can be changed as appropriate.

● A plurality of pairs of the wall portion 34 and the slit 35 may be provided.

● The shape of the terminal body 17 of the terminal 3 is not limited to an annular shape, but may be a hook shape.

● The guiding mechanism 32 may be omitted from the connector 1.

● The cover 12 may be omitted from the connector 1.

● In the terminal 3, the parts temporarily positioned by the temporary positioning mechanism 20 and the parts locked by the locking mechanism 28 may be any part of the terminal 3.

● Although the present disclosure has been described with respect to the embodiment, the present disclosure is understood not to be limited to the embodiment and structures. The present disclosure also encompasses various modifications and modifications within the scope of equivalents. In addition, various combinations and forms, further other combinations and forms including only one element, more elements or less elements are also within the scope of the present disclosure and within the scope of thoughts.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal holder provided in a case for accommodating a wire having a terminal mounted on a tip, the terminal being fixed to a connection partner via a fastening member, comprising:
a terminal accommodating portion for accommodating the terminal with an upper surface of the terminal exposed;
a temporary positioning mechanism for temporarily positioning the terminal in an insertion posture in the terminal accommodating portion in a process of accommodating the terminal into the terminal accommodating portion; and
a locking mechanism for locking the terminal in the terminal accommodating portion when the terminal temporarily positioned by the temporary positioning mechanism is pushed and accommodated into the terminal accommodating portion,
the terminal being fixed to the terminal accommodating portion by the temporary positioning mechanism and the locking mechanism.

2. The terminal holder of claim 1, wherein the temporary positioning mechanism has a structure including:
a protrusion formed on one of the terminal and the terminal accommodating portion; and
a recess formed in the other of the terminal and the terminal accommodating portion to be engaged with the protrusion.

3. The terminal holder of claim 1, wherein the temporary positioning mechanism has a structure including:
a supporting portion formed in the terminal accommodating portion, the supporting portion positioning and supporting the terminal in the insertion posture; and
a restricting portion formed in the terminal accommodating portion, the restricting portion restricting a movement of the terminal by sandwiching a part of the terminal between the supporting portion and the restricting portion.

4. The terminal holder of claim 3, wherein:
the temporary positioning mechanism includes:
a contact portion formed in the terminal for contacting the restricting portion; and
a pair of terminal protrusions formed on both sides of the contact portion in the terminal, the pair of terminal protrusions being positioned by the supporting portions when the terminal is inserted in the insertion posture into the terminal accommodating portion, and
a plurality of pairs of the supporting portion and the terminal protrusion are provided.

5. The terminal holder of claim 1, wherein the temporary positioning mechanism includes a plurality of differently structured components.

6. The terminal holder of claim 1, comprising a guiding mechanism for guiding the terminal in the insertion posture to the temporary positioning mechanism when the terminal is inserted into the terminal accommodating portion.

7. The terminal holder of claim 1, wherein the terminal accommodating portion is formed with a wall portion to be engaged with a slit of the terminal to make the terminal fixed to the terminal accommodating portion hardly move.

8. The terminal holder of claim 1, wherein:
a part temporarily positioned by the temporary positioning mechanism is a tip of the terminal, and
a part locked by the locking mechanism is a part around a crimping portion in the terminal including the crimping portion to be fixed to the wire.

9. A terminal to be mounted on a tip of a wire and accommodated into a terminal accommodating portion provided in a case for accommodating the wire with an upper surface of the terminal exposed, comprising:
a part to be temporarily positioned in the terminal accommodating portion when the terminal takes an insertion posture in a process of being accommodated into the terminal accommodating portion and to be fixed to the terminal accommodating portion when the terminal is accommodated into the terminal accommodating portion; and
a part to be fixed to the terminal accommodating portion by being pushed after temporary positioning, accommodated into the terminal accommodating portion and locked in the terminal accommodating portion.
